(19) United States
(12) Patent Application Publication
(10) Pub. No.: US 2011/0041572 A1
(43) Pub. Date: Feb. 24, 2011

(54) METHOD OF MANUFACTURING A MOTOR VEHICLE DOOR LOCK

(75) Inventors: Jean-Marie Lefebvre, Creteil Cedex (FR); Francois Bernier, Creteil Cedex (FR); Laurent Duriez, Creteil Cedex (FR); Patrick Dupont, Creteil Cedex (FR)

Correspondence Address: OSHA LIANG L.L.P., TWO HOUSTON CENTER, 909 FANNIN, SUITE 3500, HOUSTON, TX, 77010, US

(73) Assignee: VALEO SECURITE HABITACLE, Creteil Cedex (FR)

(21) Appl. No.: 12/746,824

(22) PCT Filed: Dec. 5, 2008
(86) PCT No.: PCT/EP08/66885

§ 371 Date: Nov. 10, 2010

(30) Foreign Application Priority Data
Dec. 11, 2007 (FR) 0759711

(51) Int. Cl. E05B 65/12; B23P 11/00; E05B 63/00

(52) U.S. Cl. 70/237; 29/428

(57) ABSTRACT

The invention relates to a method of manufacturing locks for doors of a plurality of models of motor vehicles, each lock comprising a latch (1) which is rotatable about an axis (A) and which is associated with a pawl (2) rotatable about an axis (B), and also a mechanical and/or electrical transmission arrangement for carrying out an identical list of commands, the positioning of the fastening points (3, 4, 5) of these locks being identical, and the relative positioning of their “S point” (S1, S2) being different. According to the invention, said mechanical and/or electrical transmission arrangement of each of the locks is identical and only the assembly consisting of the latch and the associated pawl is different for each model of vehicles, in order to achieve said positioning of the “S point”.

The invention relates to a method of manufacturing a motor vehicle door lock.

A lock in general comprises a latch the function of which is to engage with a strike post carried by the vehicle and a pawl the function of which is to immobilize the latch in the closed position.

These two main components are controlled by a mechanical and/or electrical transmission arrangement, often in a number of kinematic planes, to allow the door to be opened and closed, locked and unlocked in the conventional way, locked and unlocked using the pull stalk, child locked, deadlocked, etc.

It is becoming increasingly commonplace for motor vehicle manufacturers to demand the same list of possible commands in the locks that they wish to mount on their vehicle.

Further, a lock is defined by its points for attachment to the bodywork of the vehicle. Specifically, the points, of which there are generally three, each consist of a screw fastening or equivalent arrangement passing through the lock at a point thereon where it is impossible to run lever or equivalent kinematics. These points of attachment therefore constitute a significant constraint in the design of the lock.

A lock is also defined by what is known as its “S point” which is the position of the strike post on the second notch, that is to say the position of the strike post in the closed position. In this position, the strike post is at the end of its travel near the closed end of a throat and this position is generally defined by the positioning of the strike post in relation to the points of attachment of the lock.

When a motor vehicle manufacturer requires the manufacture of a lock for one model of vehicle, he therefore essentially specifies the positioning of the three points of attachment and of the “S point” with respect to these attachment points. Sometimes it so happens that the positioning of the three attachment points is identical for several models of vehicles and only the relative position of the “S point” differs.

In such instances the lock is currently designed entirely, with all its required opening kinematics and controls, on the basis of these positions. This design and the ensuing manufacture are relatively complex and lengthy, and therefore expensive.

The invention solves this problem in cases where, for several models of motor vehicles, an identical list of commands and identical attachment points are required, the position of the “S point”, however, differing according to the model, that is to say that the strike post in the closed position differs with respect to the throat depending on the model.

To do that, the invention provides a method for manufacturing locks for the doors of a plurality of models of motor vehicle, each lock comprising a rotary latch that rotates about an axis and is associated with a rotary pawl that rotates about an axis, and a mechanical and/or electrical transmission arrangement for performing an identical list of commands, the positioning of the attachment points of these locks being identical and the relative positioning of their “S points” differing with respect to a throat, the method being characterized in that said mechanical and/or electrical transmission arrangement for each of the locks is identical and only the latch and associated pawl assembly differs for each model of vehicle, so as to achieve said positioning of the “S point”.

Essential lock standardization is thus achieved, the vast majority of the components being standardized. As a result, the assembly lines are significantly simplified.

According to a preferred embodiment, the position of the axis of rotation of said latch and the position of the axis of rotation of said pawl are identical.

For preference, said pawl of each lock is also identical.

Maximum lock standardization is thus obtained, only the latch not being standardized.

The invention is described hereinbelow in greater detail with the aid of figures that depict only preferred embodiments of the invention.

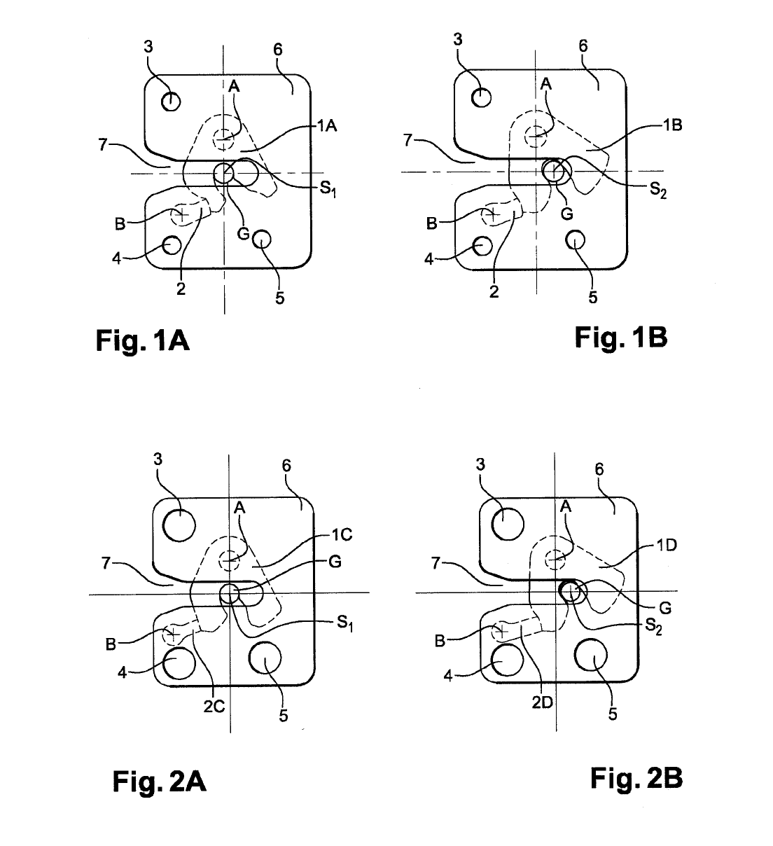

FIG. 1A is a view of a latch and pawl assembly on a backing plate, of a lock of a first model of vehicle, according to a first preferred embodiment of the invention.

FIG. 1B is a view of a latch and pawl assembly on a backing plate of a lock of a second model of vehicle, according to this first preferred embodiment of the invention.

FIG. 2A is a view of a latch and pawl assembly on a backing plate of a lock of a first model of vehicle, according to a second preferred embodiment of the invention.

FIG. 2B is a view of a latch and pawl assembly on a backing plate of a lock of a second model of vehicle according to this second preferred embodiment of the invention.

A lock comprises the rotary latch 1 that rotates about an axis A and is associated with a rotary pawl 2 that rotates about an axis B, and a mechanical and/or electrical transmission arrangement for performing a list of commands, generally in several kinematic planes not depicted in the figures. It comprises three attachment points 3, 4, 5 for attachment to the vehicle bodywork. A backing plate 6 bearing these elements is also depicted.

FIGS. 1A and 1B illustrate a first variant of the method according to the invention.

FIG. 1A illustrates the conditions required for a first model of motor vehicle and FIG. 1B illustrates the conditions required for a second model of motor vehicle.

These conditions are an identical list of commands, identical positioning of the attachment points 3, 4, 5 and different relative positioning of their different “S points” S1 and S2. In this example, the S point S1 of the lock of the first model needs to be vertically (when viewed according to the figures) aligned with the axis A of the latch 1A and the S point S2 of the lock of the second model has to be offset from this vertical alignment.

According to the method according to the invention, the mechanical and/or electrical transmission arrangement of each of the locks is identical and only the latch 1A/1B and associated pawl 2 assembly differs for each model of vehicle, so as achieve the required position of the “S point”.

The position of the axis of rotation A of the latch 1A, 1B and the position of the axis B of rotation of the pawl 2 are identical.

More specifically, in this first variant, the pawl 2 of each lock is also identical. It is therefore only by configuring the latch 1A and 1B differently that the required different positions of their “S point” are achieved, all the other elements of the locks being identical and therefore standardized.

FIGS. 2A and 2B illustrate a second variant of the method according to the invention.

Similarly, FIG. 2A illustrates the conditions required for a first model of motor vehicle and FIG. 2B the conditions required for a second model of motor vehicle.

These conditions are an identical list of commands, identical positions of the attachment points 3, 4, 5 and different relative positions of their “S points” S1 and S2 in relation to the throat. In this example, the point S1 of the lock of the first model needs to be vertically (when viewed according to the figures) aligned with the axis A of the latch and the point S2 of the lock of the second model needs to be offset in relation to this vertical alignment.

The mechanical and/or electrical transmission arrangement of each of the locks is identical and only the latch 1C, 1D and associated pawl 2C, 2D assembly differs for each model of vehicle, so as to achieve the required positioning of the “S point”.

The position of the axis of rotation A of the latch 1C, 1D and the position of the axis B of rotation of the pawl 2C, 2D are identical.

More specifically, in this second variant, the latch 1C, 1D and the pawl 2C, 2D of each lock are different. It is therefore by configuring the latch 1C, 1D and the pawl 2C, 2D differently that the required different positioning of the “S point” is achieved, all the other elements of the locks being identical and therefore standardized.

In both variants it should be noted that the throat 7 which is the passage in the path of the strike post G is also identical. Only the component known as the strike packing piece, which is generally fitted into the lock at the end of the travel of the strike post corresponding to the “S point” and against which the strike post comes to rest at the end of its travel is advantageously mounted in the corresponding position for each S point S1 and S2. This component is an auxiliary part of a lock and entirely independent of the design of this lock.

The design of the latch and of the pawl which is needed for implementing the method according to the invention is the result of design considerations within the competence of those skilled in the art.

1. A method of manufacturing a first lock and a second lock, the first lock configured to be mounted on a first model of a motor vehicle, and the second lock configured to be mounted on a second model of the motor vehicle, each of the first and second lock comprising:
attachment points, wherein a positioning of the attachment points of the first lock and of the second lock is identical;
a mechanical and/or electrical transmission arrangement for carrying out a list of commands;
rotary latch that rotates about a first axis;
a rotary pawl that rotates about a second axis;
a strike post in a closed position, which is different with respect to a throat for the first lock and for the second lock;
wherein the method comprises:
positioning the first axis of rotation of said rotary latch and the second axis of rotation of said rotary pawl of the first and second locks identically;
using the same mechanical and/or electrical transmission arrangement for the first and second locks; and
using a different rotary latch and rotary pawl assembly for the first and second locks, so as to create the strike post that is specific and different for each of the first and second locks.

2. The method as claimed in claim 1, wherein said rotary pawl of the first and second locks are identical.

3. A set of locks comprising at a first lock and a second lock, the first lock configured to be mounted on a first model of a motor vehicle, and the second lock configured to be mounted on a second model of the motor vehicle, each lock comprising:
attachment points, wherein the attachment points of the first lock and of the second lock are identical;
a mechanical and/or electrical transmission arrangement for carrying out a list of commands;
rotary latch that rotates about a first axis;
a rotary pawl that rotates about a second axis;
strike post in a closed position, which is different with respect to a throat for the first lock and for the second lock;
wherein:
the first axis of rotation of said rotary latch and the second axis of rotation of said rotary pawl of the first and second locks are identical,
the mechanical and/or electrical transmission arrangements for the first lock and for the second lock are identical,
the latch and pawl assembly for the first and for the second locks are different such that the strike post of the first lock is positioned differently than the strike post of the second lock.

4. The lock set as claimed in claim 3, wherein said rotary pawl of the first and second locks are identical.
